(19) United States
(12) Patent Application Publication
(10) Pub. No.: US 2025/0148687 A1
(43) Pub. Date: May 8, 2025

(54) DOMAIN ADAPTATION USING POSE-PRESERVED TEXT-TO-IMAGE DIFFUSION FOR 3D GENERATIVE MODEL

(71) Applicant: SEOUL NATIONAL UNIVERSITY R&DB FOUNDATION, Seoul (KR)

(72) Inventors: Se Young CHUN, Seoul (KR); Gwanghyun KIM, Seoul (KR)

(21) Appl. No.: 18/933,335

(22) Filed: Oct. 31, 2024

(30) Foreign Application Priority Data
Nov. 2, 2023 (KR) 10-2023-0149926

(51) Int. Cl. G06T 15/00; G06T 7/50

(52) U.S. Cl. CPC G06T 15/00; G06T 7/50

(57) ABSTRACT

A 3D image creation method that is performed by a server and able to adapt to domains having a large gap according to an embodiment includes: (a) collecting a plurality of training data including a set of a depth map about a source image in a first domain, a text indicative of a style of a second domain, and a target image of the second domain; (b) performing training to preserve a pose of the source image according to the depth map and converting the source image to be implemented in a style of the target image according to the text by using each of the training data; and (c) creating a plurality of 3D images corresponding to a specific domain from noise data randomly input by using a domain-adapted 3D generative model constructed based on the training and a predetermined pose parameter.

### CROSS-REFERENCE TO RELATED APPLICATION

This application claims the benefit under 35 USC 119 (a) of Korean Patent Applications No. 10-2023-0149926 filed on Nov. 2, 2023 in the Korean Intellectual Property Office, the entire disclosures of which are incorporated herein by reference for all purposes.

### TECHNICAL FIELD

The present disclosure relates to a 3D image creation technology, and more particularly, to domain adaptation using pose-preserved text-to-image diffusion across significant domain gaps and a 3D generative model based on the domain adaptation.

### BACKGROUND

A new era has arrived in which virtual images or characters are produced realistically by using deep learning technologies rather than using actually taken images and introduced into various types of content. For example, technologies have emerged that use image generative models based on GAN (Generative Adversarial Network) neural network to create virtual images that closely resemble real ones.

Further, there is a growing trend of extending 2D generative models to 3D generation technologies for creating multi-view virtual images. First, mesh-, voxel-, block- and fully implicit representation-based 3D generative models have been proposed, but these models have issues of low quality, viewpoint inconsistency, and inefficiency.

To address these issues, research is being conducted on technologies, some of which are implemented as a model combining a 2D Convolutional Neural Network (CNN) generator with neural rendering, to synthesize high-quality images with consistent multi-view perspectives and detailed 3D shapes.

Such a 3D generative model can sample multi-view 3D images based on single viewpoint 2D images. However, a large collection of images from various fields is required to train the 3D generative model similar to a 2D generative model. Also, unlike the 2D generative model, the 3D generative model needs to further pre-label a camera pose defining the viewpoint in each collected image.

Due to these unfavorable requirements for the training process, a domain of an image that a conventional 3D generative model can produce is very realistically limited. For example, the domain is limited to a region of a small number of domains, such as simulated car sets or human and animal faces.

Meanwhile, in the field of 2D image learning, adaptation technologies have been introduced that preserve original content while transforming only a style to convert an image into an image in another domain. For example, it has become possible to collect training data from various domains by adapting virtual images, such as converting an image of a human face into an image of a specific animal's face, without needing to actually take images.

However, when 3D images across a plurality of domains are created by extending adaptation technologies directly to 3D generative models, the created images often lack consistency of desired intention and viewpoint with the originals. Further, even within a single domain, different styles exist, which leads to the creation of 3D images in similar styles. Therefore, the quality is degraded in terms of diversity of images, which makes it difficult to commercialize such adaptation technologies.

Furthermore, when a 3D generative model is applied to a domain which is quite different from a source domain, a camera pose of the original is not preserved but randomly changed, or an image in a style far from that of a corresponding domain is created due to too much focusing on the pose.

That is, when domain adaptation across large domain gaps is applied according to conventional technologies, a 3D viewpoint cannot be maintained or consistency with a desired style is further degraded, which results in further degradation in quality.

### SUMMARY

In view of the foregoing, the present disclosure is conceived to provide an improved text-to-image diffusion technique by which a camera pose of the original is preserved but a style is converted according to an instruction indicated by a text, and also provide a 3D generative model that can adapt to a domain which is quite different from a source domain by using the text-to-image diffusion technique.

The problems to be solved by the present disclosure are not limited to the above-described problems. There may be other problems to be solved by the present disclosure.

An aspect of the present disclosure provides a 3D image creation method that is performed by a server and able to adapt to domains having a large gap, including: (a) a process of collecting a plurality of training data including a set of a depth map about a source image in a first domain, a text indicative of a style of a second domain, and a target image of the second domain; (b) a process of performing training to preserve a pose of the source image according to the depth map and convert the source image to be implemented in a style of the target image according to the text by using each of the training data; and (c) a process of creating a plurality of 3D images corresponding to a specific domain from noise data randomly input by using a domain-adapted 3D generative model constructed based on the training and a predetermined pose parameter.

According to an embodiment of the present disclosure, the source image and the target image are 3D images consisting of a plurality of poses associated with a plurality of camera viewpoints.

According to an embodiment of the present disclosure, the domain has at least one predetermined style, and the second domain is different from the first domain.

According to an embodiment of the present disclosure, the process (a) includes a process of acquiring the source image by inputting the pose parameter and the random noise data into the 3D generative model previously trained on the first domain and acquiring a depth value by applying the acquired source image to a pre-trained depth estimation model.

According to an embodiment of the present disclosure, the process (a) includes a process of acquiring the target image corresponding to the first domain in a different style from the source image by inputting the pose parameter and another noise data into the 3D generative model, and the text is set to correspond to the first domain.

According to an embodiment of the present disclosure, the process (a) includes a process of acquiring the target image by converting the source image to match with the style indicated by the text through a pre-trained text-to-image diffusion model.

According to an embodiment of the present disclosure, the process (a) includes a process of acquiring the target image by inputting the pose parameter and the random noise data into the 3D generative model previously trained on the second domain.

According to an embodiment of the present disclosure, the process (a) includes a process of acquiring a target image corresponding to another second domain by applying the target image created by the 3D generative model to the pre-trained text-to-image diffusion model.

According to an embodiment of the present disclosure, when the style set for the second domain includes a plurality of sub-styles, the process (b) includes a process of further dividing the text into sub-texts corresponding to the respective sub-styles and creating target images in the plurality of sub-styles by inputting the sub-texts.

According to an embodiment of the present disclosure, the process (b) includes a process of constructing a sampling model that creates the target image by using a pose-preserved diffusion model constructed through the training and the pre-trained text-to-image diffusion model.

According to an embodiment of the present disclosure, the process (b) includes a process of generating a contour and a shape of the target image in a state where the pose of the source image is preserved through the pose-preserved diffusion model and then improving details of the target image through the text-to-image diffusion model.

According to an embodiment of the present disclosure, the process (c) includes a process of creating a plurality of target images consisting of poses of the source images for a plurality of second domains by converting a style of the source image according to an instruction indicated by a text input into the sampling model.

According to an embodiment of the present disclosure, the process (c) includes

a process of constructing the domain-adapted 3D generative model by training the 3D generative model with a plurality of target images constructed by the sampling model.

According to an embodiment of the present disclosure, the process (c) includes a process of inputting the noise data and the pose parameter into the domain-adapted 3D generative model to output a new 3D image and performing fine-tuning of the output 3D image in a direction in which an adversarial loss caused by a difference between the output 3D image and the specific domain is minimized.

According to an embodiment of the present disclosure, when at least one of a plurality of styles set for the specific domain is selected, the process (c) includes a process of performing fine-tuning of a 3D image output from the domain-adapted 3D generative model corresponding to the selected style by using the noise data.

According to an embodiment of the present disclosure, when a previously collected real 2D image is mapped to a 3D embedding space and input into the domain-adapted 3D generative model, the process (c) includes a process of creating the 3D image by implementing a 3D embedding space corresponding to the specific domain.

Another aspect of the present disclosure provides a 3D image creation server, including a memory configured to store a program to perform a 3D image creation method that is able to adapt to domains having a large gap; and a processor configured to execute the program, and the processor is configured to, by executing the program, collect a plurality of training data including a set of a depth map about a source image in a first domain, a text indicative of a style of a second domain, and a target image of the second domain, perform training to preserve a pose of the source image according to the depth map and convert the source image to be implemented in a style of the target image according to the text by using each of the training data, and create a plurality of 3D images corresponding to a specific domain from noise data randomly input by using a domain-adapted 3D generative model constructed based on the training and a predetermined pose parameter.

An embodiment of the present disclosure provides a 3D generative model that can generate virtual 3D images without separate image collection.

An embodiment of the present disclosure provides a 3D generative model that can generate 3D images in various domains.

An embodiment of the present disclosure provides a 3D generative model that can adapt to various domains according to an instruction indicated by a text.

An embodiment of the present disclosure provides a 3D generative model that ensures text correspondence, realism, and depth.

An embodiment of the present disclosure provides a 3D generative model based on a diffusion model configured to delicately convert only a style of the original while preserving a viewpoint of the original.

An embodiment of the present disclosure provides a 3D generative model that can adapt to domains with significant domain gaps and thus can achieve a broad domain extension.

An embodiment of the present disclosure provides a 3D generative model that creates 3D images which are not limited to similar styles in a specific domain but have ensured diversity.

An embodiment of the present disclosure provides a 3D generative model that is improved in accuracy by selecting only an image which satisfies text correspondence and a viewpoint of the original and performing training with the selected image.

An embodiment of the present disclosure provides a 3D generative model that selects and adapts to a specific style in a domain based on diversity of a text.

An embodiment of the present disclosure provides a 3D generative model that can generate 3D images from various domains by using a 2D image composed of a single viewpoint.

### BRIEF DESCRIPTION OF THE DRAWINGS

In the detailed description that follows, embodiments are described as illustrations only since various changes and modifications will become apparent to a person with ordinary skill in the art from the following detailed description. The use of the same reference numbers in different FIG.s indicates similar or identical items.

FIG. 1 is a block diagram showing a configuration of a 3D image creation server according to an embodiment of the present disclosure.

FIG. 2 is a block diagram showing a configuration of a processor according to an embodiment of the present disclosure.

FIG. 3 is a diagram illustrating operations of a data collection unit according to an embodiment of the present disclosure.

FIG. 4 is a diagram illustrating operations of a data training unit according to an embodiment of the present disclosure.

FIG. 5 is a diagram illustrating operations of a sampling unit according to an embodiment of the present disclosure.

FIG. 6 shows a difference between an embodiment of the present disclosure and the prior art.

FIG. 7 is a diagram illustrating operations of a domain adaptation unit according to an embodiment of the present disclosure.

FIG. 8 is a diagram provided to explain creation of 3D images in sub-styles according to an embodiment of the present disclosure.

FIG. 9 is a diagram provided to explain style selection and domain adaptation according to an embodiment of the present disclosure.

FIG. 10 is a diagram provided to explain domain adaptation of 3D images through a 2D image according to an embodiment of the present disclosure.

FIG. 11 is a flowchart showing a 3D image creation method according to an embodiment of the present disclosure.

FIG. 12 and FIG. 13 show experimental data for explaining the effect of an embodiment of the present disclosure.

### DETAILED DESCRIPTION

Hereafter, embodiments will be described in detail with reference to the accompanying drawings so that the present disclosure may be readily implemented by a person with ordinary skill in the art. However, it is to be noted that the present disclosure is not limited to the embodiments but can be embodied in various other ways. In the drawings, parts irrelevant to the description are omitted for the simplicity of explanation, and like reference numerals denote like parts through the whole document.

Throughout this document, the term “connected to” may be used to designate a connection or coupling of one element to another element and includes both an element being “directly connected to” another element and an element being “electronically connected to” another element via another element. Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise.

Throughout the whole document, the term “unit” includes a unit implemented by hardware, a unit implemented by software, and a unit implemented by both of them. One unit may be implemented by two or more pieces of hardware, and two or more units may be implemented by one piece of hardware. Meanwhile, the units are not limited to the software or the hardware, and each of the units may be stored in an addressable storage medium or may be configured to implement one or more processors. Accordingly, the units may include, for example, software, object-oriented software, classes, tasks, processes, functions, attributes, procedures, sub-routines, segments of program codes, drivers, firmware, micro codes, circuits, data, database, data structures, tables, arrays, variables and the like. The components and the functions of the units can be combined with each other or can be divided up into additional components and units. Further, the components and the “units” may be configured to implement one or more CPUs in a device or a secure multimedia card.

Throughout the whole document, the term “3D image” refers to an image that is rendered with a plurality of poses based on a plurality of camera viewpoints rather than a single viewpoint.

Throughout the whole document, the term “domain” refers to a class classified by the type of an object shown in an image or its characteristics and may include a group of images in at least one common style, but criteria for classifying domains are not particularly limited. For example, an image of a human face and an image of a specific animal's face may be classified into respective domains according to predetermined criteria.

Throughout the whole document, the term “style” is a generic term for features of an image that represent a specific domain. At least one style may be set for a single domain. That is, a domain does not necessarily include only one style and it may be composed of images in a plurality of interrelated styles based on a pre-trained result. For example, if a domain is “Disney”, various characters of Disney may constitute a style. Even a single character can be expressed differently in various scenes and thus can be classified into different styles. As such, styles of a single domain can be classified hierarchically. For example, if a domain is “dog”, the domain includes “dog style” which can be further subdivided into specific breeds of dog, such as “poodle”, “dachshund”, “schnauzer”, etc.

Throughout the whole document, the term “adaptation” refers to “domain adaptation” which is a known technique to convert an image into one in a style of a different domain while retaining an object and content. The term “source image” is commonly employed in domain adaptation and refers to a 3D image of a “first domain” that is collected or created as the target for image conversion. The term “target image” is also commonly employed in the related art and refers to a 3D image of a “second domain” whose source image is converted through domain adaptation. That is, the “second domain” is defined to be distinct from the “first domain” and refers to all or part of a domain that is configured differently from the “first domain”.

Hereafter, exemplary embodiments of the present disclosure will be described in detail with reference to the accompanying drawings.

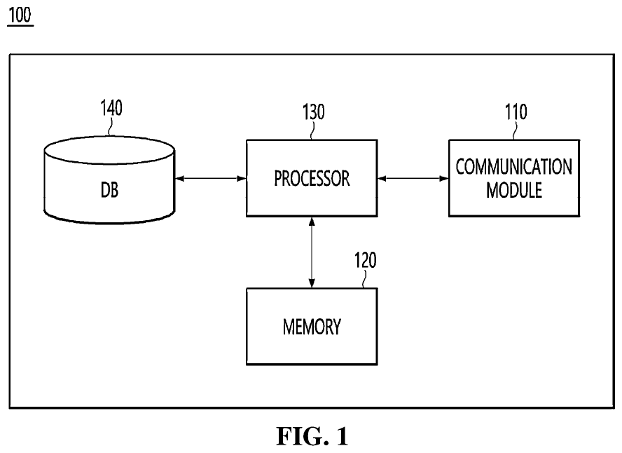

FIG. 1 is a block diagram showing a configuration of a 3D image creation server according to an embodiment of the present disclosure. Herein, the term “server” is not limited to just a term, but should be interpreted as any “device” that performs a 3D image creation method according to an embodiment of the present disclosure.

Referring to FIG. 1, a server 100 may include a memory 120 configured to store a program to perform a 3D image creation method that is able to adapt to domains having a large gap, and a processor 130 configured to execute the program.

Further, the server 100 may include a database 140 configured to store various data generated when the 3D image creation method is performed. For example, source images may be classified and stored based on the first domain, and target images converted from the source images may also be classified and stored based on the corresponding domain. Further, a 3D image newly created through domain adaptation after training of a 3D generative model is matched with the corresponding domain and stored.

Moreover, the server 100 may include a communication module 110 configured to perform data communication with a user device (not shown). For example, the server 100 can provide a user interface for 3D image creation service to the user device, which allows a user to request the generation of 3D images corresponding to various domains or a specific domain and to receive the result from the server 100.

The term “user device” to be described below may be implemented with computers or portable devices which can access a server or another device through a network. Herein, the computers may include, for example, a notebook, a desktop, a laptop, and a VR HMD (e.g., HTC VIVE, Oculus Rift, GearVR, DayDream, PSVR, etc.) equipped with a WEB browser. Herein, the VR HMD includes all of models for PC (e.g., HTC VIVE, Oculus Rift, FOVE, Deepon, etc.), mobile (e.g., GearVR, DayDream, Baofeng Mojing, Google Cardboard, etc.) and console (PSVR), and stand-alone models (e.g., Deepon, PICO, etc.). The portable devices are, for example, wireless communication devices that ensure portability and mobility and may include a smart phone, a tablet PC, a wearable device and various kinds of devices equipped with a communication module such as Bluetooth (BLE, Bluetooth Low Energy), NFC, RFID, ultrasonic waves, infrared rays, WiFi, LiFi, and the like. Further, the term “network” refers to a connection structure that enables information exchange between nodes such as devices, servers, etc. and includes LAN (Local Area Network), WAN (Wide Area Network), Internet (WWW: World Wide Web), a wired or wireless data communication network, a telecommunication network, a wired or wireless television network, and the like. Examples of the wireless data communication network may include 3G, 4G, 5G, 3GPP (3rd Generation Partnership Project), LTE (Long Term Evolution), WIMAX (World Interoperability for Microwave Access), Wi-Fi, Bluetooth communication, infrared communication, ultrasonic communication, VLC (Visible Light Communication), LiFi, and the like, but may not be limited thereto.

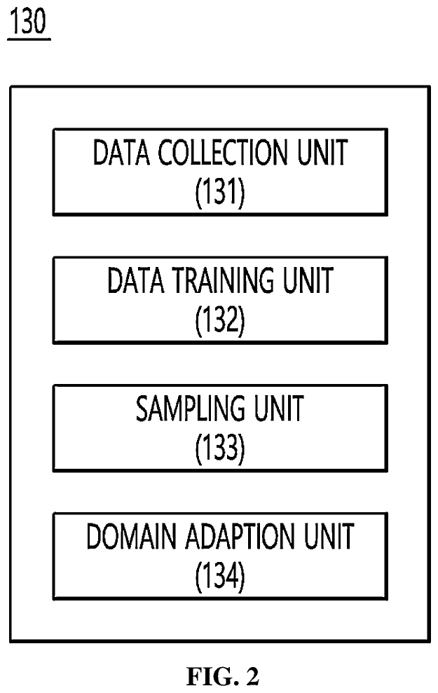

Meanwhile, the processor 130 can perform various functions as the program stored in the memory 120 is executed, and the components included in the processor 130 can be subdivided and defined based on respective functions. FIG. 2 is a block diagram showing a configuration of a processor according to an embodiment of the present disclosure.

Referring to FIG. 2, the processor 130 may include a data collection unit 131, a data training unit 132, and a domain adaptation unit 134. According to an embodiment, the processor 130 may further include a sampling unit 133.

The data collection unit 131 according to an embodiment serves to collect training data for domain adaptation training. Specifically, it collects data for training a model that maintains a pose of a source image while generating a target image. In the present disclosure, the model is defined as a pose-preserved diffusion model (PPD).

The PPD is an improvement of a conventional text-to-image diffusion model. Herein, a representative example of the conventional model is a depth-guided diffusion model (DGD). The DGD is designed to create images conditioned on depth values and text as conditions, but it focuses primarily on maintaining a pose, which imposes constraints on the shape or style. Particularly, when a text requiring significant style conversion from a source image is input, a biased image with low text correspondence can be created.

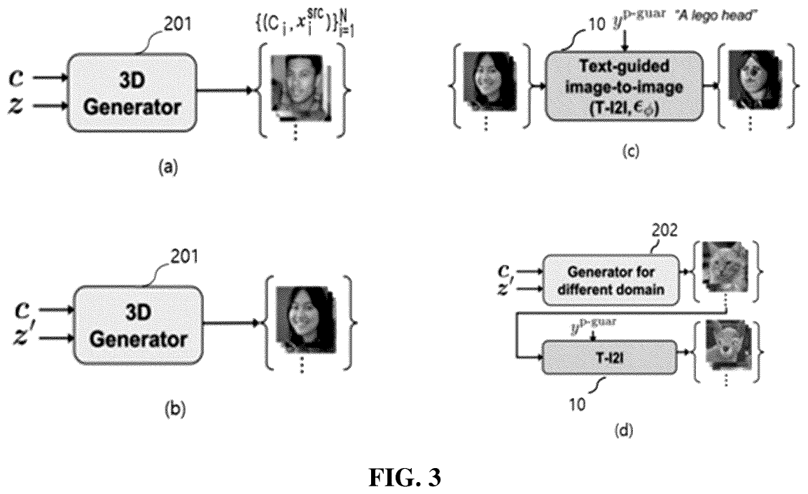

The PPD is trained to solve the problem of the conventional model. To this end, training data including a set of a depth map about a source image in a first domain, a text indicative of a style of a second domain, and the target image from the second domain is needed. The present disclosure proposes embodiments for collecting training data, which will be explained with reference to FIG. 3. FIG. 3 is a diagram illustrating operations of a data collection unit according to an embodiment of the present disclosure.

Referring to FIG. 3A, the data collection unit 131 may generate a source image by using a pre-trained 3D generative model 201. That is, since it is difficult to create a vast number of 3D images, the 3D generative model 201 can be used to easily create 3D images in various styles corresponding to the first domain based on a predetermined camera viewpoint.

Specifically, the data collection unit 131 may acquire the source image by inputting random noise data and a pose parameter into the 3D generative model 201 previously trained on the first domain. For example, the data collection unit 131 may extract a plurality of latent vectors by sampling random points based on a Gaussian distribution and vectorizing them. In this case, an identifier corresponding to a specific style of the first domain may be set for the noise data. Also, the pose parameter is distribution information of a camera pose set for each of a plurality of camera viewpoints and thus can be used to regulate the directionality of the source image.

According to an embodiment, the design type or learning model of the 3D generative model 201 is not specifically limited, but may be a model that combines a 2D CNN-based generator and neural rendering. Particularly, the 3D generative model 201 is designed as a StyleGAN2 generator incorporated with 3D-induced bias from a neural radiance field (NeRF). Accordingly, the 3D generative model 201 can sample an infinite number of source images in real time through training based on single viewpoint images. Also, the 3D generative model 201 can generate a source image with the latest quality, multi-view consistency and detailed 3D shape by using a hybrid triplane representation and performing conditional dual discrimination.

After the source image is acquired, the data collection unit 131 applies the source image to a pre-trained depth estimation model to acquire a depth map of the source image. The depth map is depth information of the image, which can be used later to preserve a pose of the source image. The type of the depth estimation model is not particularly limited.

Meanwhile, an embodiment of the present disclosure proposes a pipeline for collecting target images from the second domain that have the same pose as the source image but different styles. Conceptual examples of this are illustrated in FIGS. 3B, 3C and 3D.

Referring to FIG. 3B, the data collection unit 131 may create a target image by using the 3D generative model 201 of the first domain. In this case, a pose parameter input into the 3D generative model 201 is the same as that of the source image, but noise data input into the 3D generative model 201 is different from that of the source image. Herein, another style of the first domain may be set for the noise data. As a result, the target image corresponding to the first domain in a different style from the source image can be acquired by the 3D generative model 201. In this case, a text input for training the diffusion model is set corresponding to the first domain. That is, the first domain is set as the second domain, and a corresponding text is acquired.

Referring to FIG. 3C, the data collection unit 131 may acquire the target image by converting the source image to match with a style indicated by a text of the second domain through a pre-trained text-to-image diffusion model 10. For example, if the first domain is “human face” and the second domain is “LEGO”, a source image containing a human face and a text indicative of “LEGO style” may be input and a target image acquired by converting the human face in the source image into a LEGO character may be output.

Herein, the text-to-image diffusion (T2I) model 10 is trained with a large dataset of image-text pairs and preferably designed through a stochastic generation process. For example, a previously known stable diffusion (SD) model may be used, but the present disclosure is not limited thereto. The T2I model 10 can ensure the diversity of styles inherent in the text and offer text correspondence and pose consistency. Further, biased words or sentences can be excluded from the text input into the T2I model to implement various styles of the second domain.

Referring to FIG. 3D, the data collection unit 131 may acquire a target image by inputting the pose parameter and the random noise data into a 3D generative model 202 previously trained on the. Herein, the input pose parameter is the same as that of the source image. For example, if the first domain is “human”, a target image of a cat's face based on the noise data with a pose of the source image can be created by using the 3D generative model 202 trained on “cat” different from the first domain.

Further, target images corresponding to other second domains may be acquired by applying the target image created by the 3D generative model 202 to the T2I model 10. Herein, the type of the T2I model 10 may be the same as that of the model shown in FIG. 3C. For example, after the target image of the “cat” domain is created, it can be used as the source image for the T2I model 10, and the T2I model 10 can create a target image of a cat face converted into a Disney character according to a text indicative of a style of a “Disney” domain.

As described above, according to an embodiment of the present disclosure, a vast number of target images with the same pose but in different styles from the source image can be collected. Also, the diversity of the domains and styles of the target images can be ensured.

Meanwhile, the 3D generative models 201 and 202 operating through the data collection unit 110 are in a pre-trained state before domain adaptation, and can be adjusted to 3D generative models incorporated with domain adaptation later on. In the present disclosure, such 3D generative models are defined as “domain-adapted 3D models” for distinction.

The data training unit 132 according to an embodiment performs training to preserve a pose of the source image according to the depth map and convert the source image to be implemented in a style of the target image according to the text by using each of the training data collected by the data collection unit 131.

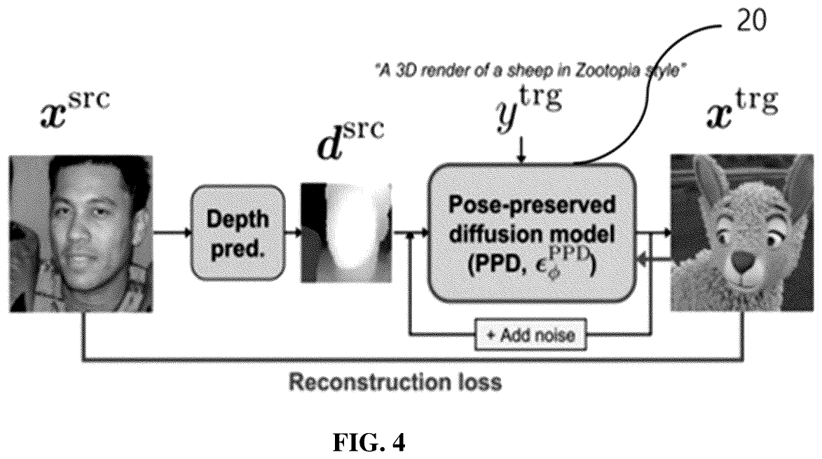

Referring to FIG. 4, the data training unit 132 trains a pose-preserved diffusion model 20 with each of the training data. When a depth map d^{src} of a source image x^{src} constituting the training data and a text y^{trg} indicative of a style set for the second domain are input as conditions, the pose-preserved diffusion model 20 is trained to convert the source image x^{src} to be output with a target image x^{trg} of the second domain.

The data training unit 132 may perform training by fine-tuning a pre-trained depth-guided diffusion model (DGD) so that the depth map d^{src} is applied intensively to the pose of the image to maintain the pose as it is like the source image and flexibly convert the style according to the text.

Herein, sampling of the image may be performed based on, for example, a denoising diffusion model. In this case, the target image is created by gradually removing noise from the random noise data in reverse from t=T to t=0. Specifically, in each denoising process, the text is applied to create an image corresponding to the style indicated by the text, and in each process, the depth map is further applied to adjust the image to correspond to the pose of the depth map. In this way, the target image x^{trg} of which the pose is restored can be trained in a direction in which a reconstruction loss corresponding to a difference from the source image is minimized.

Meanwhile, although the pose-preserved diffusion model 20 exhibits excellent performance in creating a target image with a restored pose, it is likely to be trained with relatively less data compared to a conventional text-to-image diffusion model. Therefore, the pose-preserved diffusion model 20 may result in biased details (e.g., partial color shifts) due to the inherent style in the training data.

In this regard, according to an embodiment, the sampling unit 133 may construct a sampling model that creates a target image by using the pose-preserved diffusion model 20 constructed through training and the pre-trained T2I model 10.

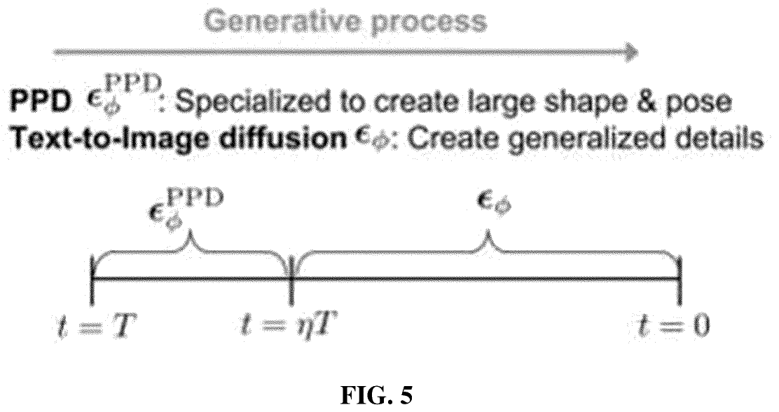

Specifically referring to FIG. 5, the sampling unit 133 generates a contour and a shape of the target image by using the pose-preserved diffusion model 20 during a predetermined initial period nT of a total diffusion period T for creating the target image. Then, in the remaining diffusion period 1−n) T, the sampling unit 133 uses the T2I model 10 for Stable Diffusion (SD) or the like to improve details of the target image whose contour and shape have been generated. That is, an image is first created by using the characteristics of the pose-preserved diffusion model to preserve the pose and correspond to the text as closely as possible, and then detailed information of the image is generated and applied by using the advantages of SD, which has been trained with a vast amount of data, to secure a high-quality 3D image.

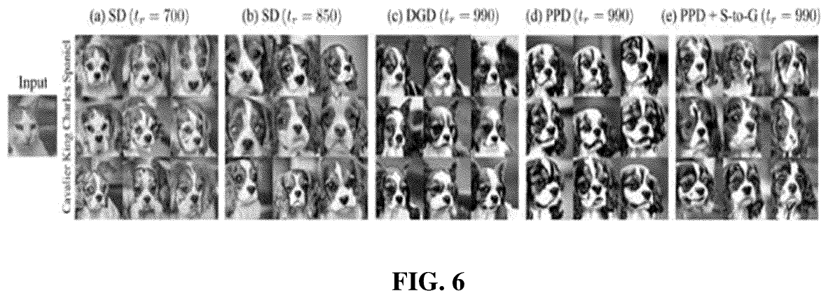

As described above, the sampling unit 133 can construct a sampling model 30 configured to perform sampling based on the pose-preserved diffusion model 20, and FIG. 6 shows examples of images created by using the conventional text-to-image diffusion model, images created by using the pose-preserved diffusion model 20, and images created by using the sampling model 30.

Specifically, FIG. 6 shows the result of applying “cat face” as a source image and “spaniel puppy face” as a text to the Stable Diffusion (SD), the depth-guided diffusion model (DGD), the pose-preserved diffusion model (PPD), and the sampling model (PPD+S-to-G). It can be seen that the SD creates an image with lower text correspondence and pose consistency than the PPD and the sampling model. It can be seen that the DGD creates an image with a preserved pose but lower text correspondence, which results in ambiguity between a cat and a puppy. Meanwhile, it can be seen that the PPD creates an image with a preserved pose and more sufficient reflection of a text than the conventional model, and, thus, the spaniel breeds are distinctly represented. Further, it can be seen that the sampling model based on the PPD creates an image with further improved details, such as detailed color and shape, than the PPD.

The domain adaptation unit 134 according to an embodiment constructs a domain-adapted 3D generative model based on the above-described training result and uses it to create a plurality of 3D images corresponding to a specific domain from randomly input noise data and a predetermined pose parameter.

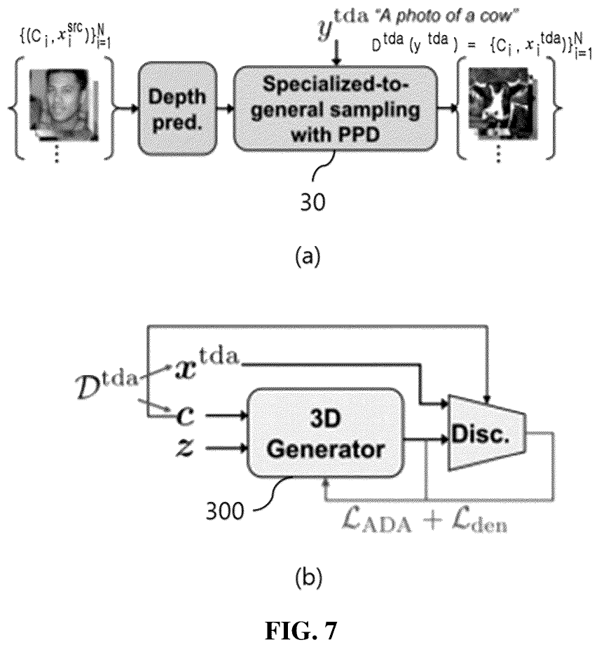

Referring to FIG. 7A, the domain adaptation unit 134 may create Number of target images for a plurality of second domains by converting styles of N number of source images corresponding to the first domain according to an input text through the pose-preserved diffusion model 20 or the sampling model 30 of which the latter is preferable. For example, if the first domain is “human face” and the second domain is “Pixar”, a source image containing a human face and a text indicative of “Pixar style” may be input and target images acquired by converting the human face in the source image into various characters of Pixar may be output while preserving the pose of the human face in the source image. The domain adaptation unit 134 may repeat this process to collect a pose recognition dataset consisting of noise data, source images, and target images for adaptation to various domains different from the first domain.

Referring to FIG. 7B, the domain adaptation unit 134 performs training for domain adaptation of the pre-constructed 3D generative model 201 with the plurality of collected target images. More precisely, it is possible to construct a domain-adapted 3D generative model 300 configured to perform non-adversarial fine-tuning or adversarial fine-tuning with a pose recognition dataset consisting of noise data, source images, and target images.

In the non-adversarial fine-tuning, a CLIP-based loss is used, but this may result in concerns of creating a 3D image with reduced diversity and somewhat lower quality due to deterministic embedding. Therefore, it is desirable to preserve diversity by using an adversarial neural network-based loss. The type of the adversarial neural network is not necessarily limited. Herein, a representative example of the adversarial neural network is StyleGAN-ADA.

Specifically, the domain adaptation unit 134 may output a new 3D image by inputting random noise data and a predetermined pose parameter into the domain-adapted 3D generative model 300. Subsequently, domain-specific conversion is performed on the 3D image, and an adversarial loss LADA and a density regularization loss Lden can be used in a discriminative learning process.

First, the adversarial loss LADA corresponds to the similarity (difference) between the 3D image output by the domain-adapted 3D generative model 300 and a target image of a specific domain. Accordingly, the domain adaptation unit 134 trains the domain-adapted 3D generative model 300 in a direction in which the adversarial loss LADA is minimized to perform fine-tuning to convert the newly output 3D image in a desired domain style. Meanwhile, the adversarial loss can be calculated using the following equation where the function f is expressed by f(u)=−log(1+exp(−u).

$${ℒ}_{ADA} = {𝔼}_{z ∼ Z , c ∼ C} [ f ( {D}_{ψ} ( A ( {G}_{θ} ( z , c ) ) , c ) ] + {𝔼}_{( c , {x}^{trg} ) ∈ {D}_{f}} [ f ( - {D}_{ψ} ( A ( {x}^{trg} ) , c ) + λ {‖ ∇ {D}_{ψ} ( A ( {x}^{trg} ) , c ) ‖}^{2} ) ] \qquad [ Equation 1 ]$$

The density regularization loss Lden corresponds to the smoothness of the density, which suppresses an unintended distortion in the shape of a newly created 3D image in a specific domain. Specifically, the domain adaptation unit 134 selects random points v from the volume V of each scene that composes the 3D image and further selects perturbed points distorted by Gaussian noise 8v. Then, the domain adaptation unit 134 calculates a loss L between the predicted densities by using the following equation, and trains the 3D generative model 300 in a direction in which the loss L is minimized.

$${ℒ}_{den}^{θ} = {𝔼}_{v ∈ V} [ ‖ {σ}_{θ} ( v ) - {σ}_{θ} ( v + δ v ) ‖ ] \qquad [ Equation 2 ]$$

Through this process, the domain adaptation unit 134 can create a 3D image in a new first domain by using the domain-adapted 3D generative model 300 and then convert it into various domains. This enables the creation of an infinite number of 3D images in various styles for each domain. For example, if the first domain is “human face” and the user requests a 3D image converted into a “Disney” style, the server 100 may create 3D images in various styles in the form of various characters of Disney through domain adaptation of a 3D image containing a human face and provide the created 3D images to a user device. Further, the creation of an image of which the pose is changed or the expression capability is degraded based on the pose-preserved diffusion model 20 and the sampling model 30 is minimized, and, thus, it is efficient in that a process of collecting a dataset does not necessarily require additional filtering. Also, the domain-adapted 3D generative model 300 can be applied to domains significant different in style from the first domain.

Meanwhile, in a process of creating a target image, there may be a tendency to train only on a specific style among various styles set for the second domain or its similar style. Particularly, if a style set for the second domain and a text corresponding thereto includes a hierarchy of concepts, training may be performed intensively on a specific sub-style. For example, when the second domain is “dog” and “3D rendering in dog style” is input as a text, a target image acquired by performing intensive training only on a specific breed of dog (e.g., poodle) may be predominantly expressed in poodle style.

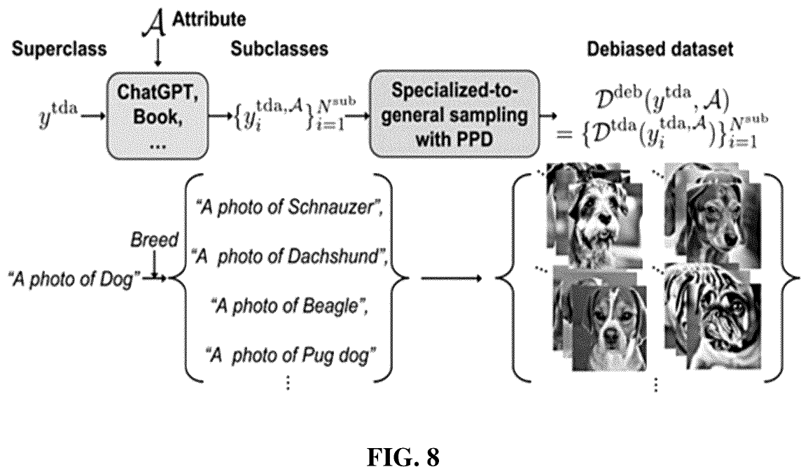

In a related embodiment, the data training unit 132 can subdivide a text into sub-texts corresponding to respective sub-styles and perform training, and, thus, target images with ensured diversity can be created in a plurality of sub-styles. For example, referring to FIG. 8, the second domain is “dog”, which can be further subdivided into various breeds. To achieve this, the data training unit 132 can subdivide a text indicative of a dog into sub-texts classified into various breeds, such as schnauzer, dachshund, etc., by using a pre-trained large language model or data retrieval, and input these sub-texts into the pose-preserved diffusion model 20 or the sampling model 30. As a result, it can be seen from FIG. 8 that target images including a plurality of breeds rather than a specific breed (style) are created in various sub-styles. Subsequently, the domain adaptation unit 134 can perform fine-tuning of a conventional 3D generative model based on the trained diffusion models 20 and 30 to construct the domain-adapted 3D generative model 300 capable of creating 3D images in various sub-styles inherent in the input text.

Meanwhile, for example, there may be a situation where a 3D image in only a specific style is needed, such as only a specific character in the “Disney” domain is needed. In this regard, according to an embodiment for maximizing the diversity, the domain adaptation unit 134 can create a 3D image in only one of a plurality styles set for a specific domain or its similar style.

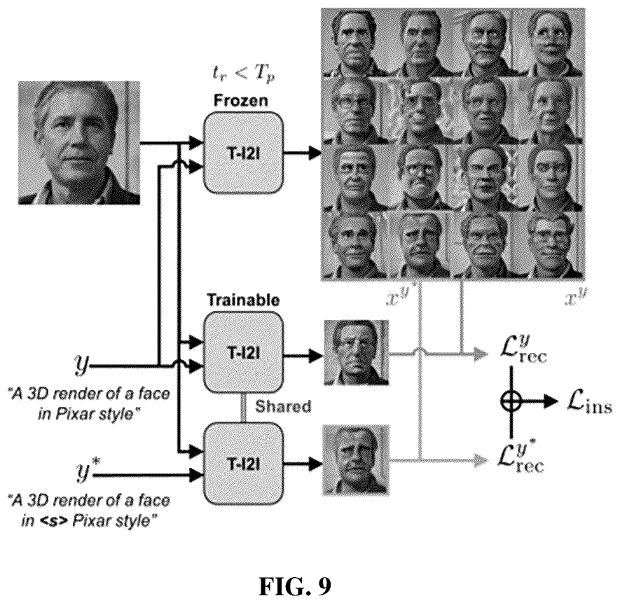

Referring to FIG. 9, for example, if the second domain is “Pixar”, target images in various styles of Pixar can be acquired through diffusion models including the pose-preserved diffusion model 20 or the sampling model 30. Herein, it is possible to select one style <s> desired by the user and perform fine-tuning of the diffusion model according to that style <s>. In this case, the diffusion model can be tuned only with an image of the style <s> by limiting a diffusion process from 0 to a pose consistency step T_{P} using a loss Lᵢₙₛ defined by the following equation. Herein, y represents a text indicative of Pixar, x^{y} is a target image created by using y, y* is a text with the additionally specified style <s>, and x^{y}* is a target image created in the style <s> by using y*.

$${𝔼}_{ϵ ∼ N ( 0 , 1 ) , t ∈ [ 0 , {T}_{P} ]} [ {‖ ϵ - {ϵ}_{ϕ} ( {E}^{V} ( {x}^{{y}^{*}} ) , t , {y}^{*} ) ‖}_{2}^{2} ] + {𝔼}_{z ∈ {\{ {E}^{V} ( {x}_{t}^{y} ) \}}_{t = 1}^{{N}_{d}} , ϵ ∼ N ( 0 , 1 ) , t ∈ [ 0 , {T}_{p} ]} [ {‖ ϵ - {ϵ}_{ϕ} ( {z}_{t} , t , y ) ‖}_{2}^{2} ] \qquad [ Equation 3 ]$$

Then, the server 100 can replace the conventional diffusion models 20 and 30 with the tuned diffusion model. Therefore, the domain adaptation unit 134 can perform fine-tuning of the newly output 3D image to correspond to the selected style <s>, and, thus, it is possible to create a plurality of 3D images in the style <s> among styles of Pixar.

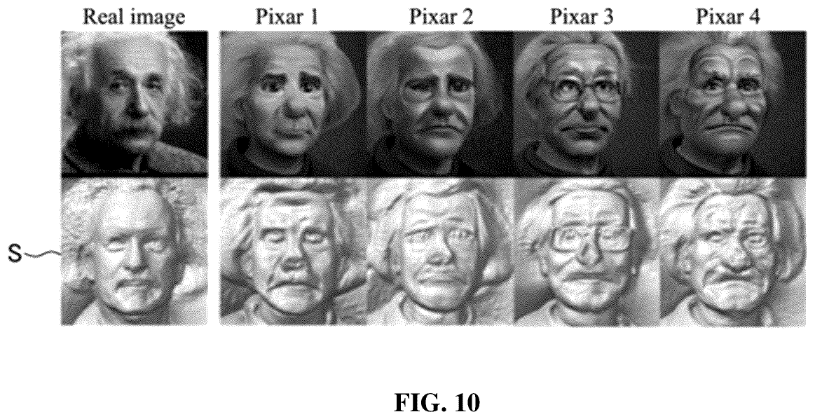

According to an embodiment, the domain adaptation unit 134 can also create 3D images in various styles across a plurality of domains based on a previously collected real 2D image. Referring to FIG. 10, a technique such as GAN inversion can be used to map the real image to a 3D embedding space S. Then, a 3D embedding space for a specific domain can be obtained by inputting the real image into the domain-adapted 3D generative model 300, and based on this, 3D images in various styles of the corresponding domain can be created. As described above, the present embodiment demonstrates that 3D images in a desired domain and style can be created even using a single viewpoint image.

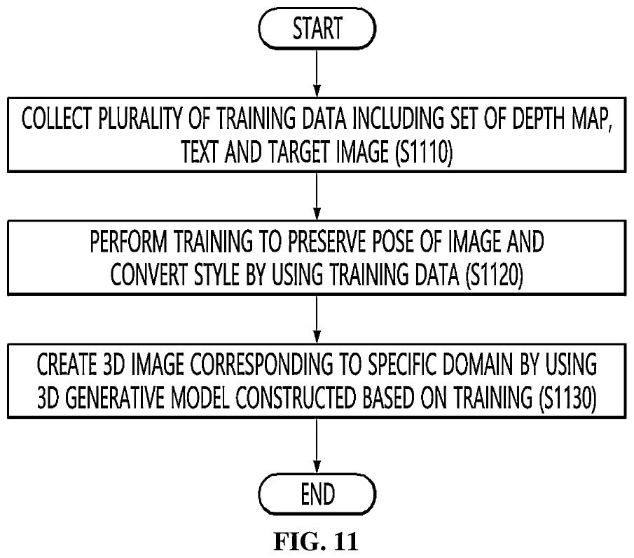

Hereafter, a 3D image creation method to be performed by the server 100 will be described with reference to FIG. 11. FIG. 11 is a flowchart showing a 3D image creation method according to an embodiment of the present disclosure. Herein, processes of the 3D image creation method correspond to the operations of the server 100, detailed description thereof will be substituted with the above description.

In a process S1110, the server 100 collects a plurality of training data including a set of a depth map about a source image in a first domain, a text indicative of a style of a second domain, and a target image of the second domain.

In an embodiment, the server 100 acquires the source image by inputting a pose parameter and random noise data into the 3D generative model previously trained on the first domain and acquires a depth value by applying the acquired source image to a pre-trained depth estimation model.

In an embodiment, the server 100 acquires the target image corresponding to the first domain in a different style from the source image by inputting the pose parameter and another noise data into the 3D generative model trained on the first domain. Herein, the text is set to correspond to the first domain.

In an embodiment, the server 100 acquires the target image by converting the source image to match with the style indicated by the text through a pre-trained text-to-image diffusion model.

In an embodiment, the server 100 acquires the target image by inputting the pose parameter and the random noise data into the 3D generative model previously trained on the second domain. Also, it is possible to further acquire a target image corresponding to another second domain by applying the acquired target image to the pre-trained text-to-image diffusion model. In a process S1120, the server 100 performs training to preserve a pose of the source image according to the depth map and convert the source image to be implemented in a style of the target image according to the text by using each of the training data.

In an embodiment, the server 100 trains and constructs a pose-preserved diffusion model by using the training data.

In an embodiment, the server 100 constructs a sampling model that creates the target image by using the pose-preserved diffusion model and the pre-trained text-to-image diffusion model.

Specifically, the server 100 generates a contour and a shape of the target image in a state where the pose of the source image is preserved through the pose-preserved diffusion model in the sampling model and then improves details of the target image through the text-to-image diffusion model.

In an embodiment, when the style set for the second domain includes a plurality of sub-styles, the server 100 further divides the text into sub-texts corresponding to the respective sub-styles and creates target images in the plurality of sub-styles by inputting the sub-texts.

In a process S1130, the server 100 creates a plurality of 3D images corresponding to a specific domain from noise data randomly input by using a domain-adapted 3D generative model constructed based on the training and a predetermined pose parameter.

In an embodiment, the server 100 creates a plurality of target images consisting of poses of the source images for a plurality of second domains by converting a style of the source image according to an instruction indicated by a text input into the sampling model, and collects them as a pose recognition dataset.

Subsequently, the server 100 constructs a domain-adapted 3D generative model by training the previously constructed 3D generative model with the collected dataset.

In an embodiment, the server 100 outputs a new 3D image by inputting random noise data and a pose parameter into the domain-adapted 3D generative model. Then, the output 3D image is fine-tuned in a direction in which an adversarial loss caused by a difference between the output 3D image and the specific domain is minimized.

In an embodiment, the server 100 selects at least one of a plurality of styles set for the specific domain and fine-tunes the 3D image output from the domain-adapted 3D generative model using the noise data to correspond to the selected style.

In an embodiment, when a previously collected real 2D image is mapped to a 3D embedding space and input into the domain-adapted 3D generative model, the server 100 creates the 3D image by implementing a 3D embedding space corresponding to the specific domain.

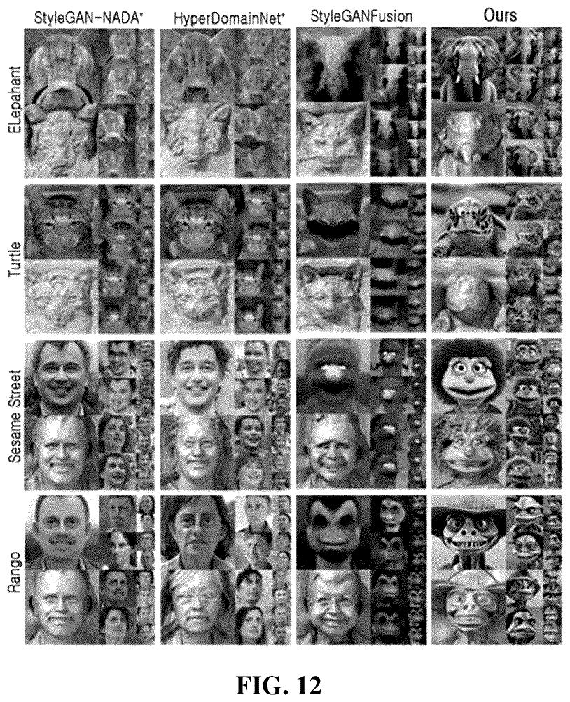

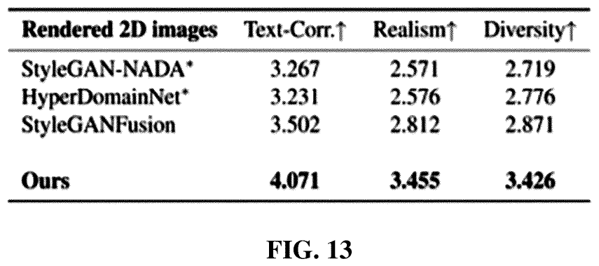

Hereafter, experimental data and the supported effects according to an embodiment of the present disclosure will be confirmed from FIGS. 12 and 13. Although FIG. 12 shows 2D images due to limitations of the drawing format, they actually represent 3D images associated with a plurality of viewpoints.

First, to provide a comparison with the present disclosure, conventional representative domain-adapted models used in the experiment will be briefly introduced. One of them is StyleGAN-NADA, which is composed of an image encoder and a text encoder and designed based on a space defined by CLIP that converts inputs into vectors. StyleGAN-NADA enables alignment of a CLIP space direction between a source image and a target image with a direction between the source image and a text. That is, StyleGAN-NADA can shift the first domain to the second domain using a text guided by a CLIP loss based on a pre-trained StyleGAN2 generator.

Another model is HyperDomainNet, which is based on CLIP and additionally proposes a domain modulation technique to reduce the number of training parameters and an in-domain angle consistency loss. The other one is StyleGANFusion, which adopts an SDS loss as guidance of text adaption of 2D and 3D generative models based on text-to-image diffusion.

However, these models have a limitation in that they fail to reflect various styles inherent in texts. That is, due to deterministic embedding of the CLIP encoder, an image in only one style or its similar style in a domain may be created, which causes limitations in diversity. For example, it can be seen “Disney”, which includes various characters and styles, is more highly likely to be implemented as a target image with a specific character in a CLIP-based model.

Returning to the experiment, domain adaptation was performed by simply extending the conventional models, such as StyleGANFusion, StyleGAN-NADA, and HyperDomainNet, into 3D images. In contrast, domain adaptation of the present disclosure was performed by using the 3D generative model trained based on the pose-preserved diffusion model. A first domain used a source image showing a human face as a human, and a conversion target domain was set to an elephant, a turtle, the Sesame Street series, and the animated film Rango.

FIG. 12 shows 3D images created according to the prior art and those created according to the present disclosure. A comparison reveals that images were output that were difficult to recognize as any particular object due to non-correspondence to a text according to the prior art. Particularly, images showing characters from the series or animated film, which almost look like humans, were output. Also, most of the images were created in similar styles, showing a lack of diversity. Thus, not only was the quality low, but the images created for the domains with significant differences from humans were unusable. In contrast, high-quality images with high text correspondence and pose consistency were acquired according to the present disclosure even though all the domains were significantly different from humans, and were created in different styles, showing a remarkable improvement in diversity.

FIG. 13 is a table displaying the quantitative results of users' assessment on the quality of the 3D images created according to the prior art and the present disclosure. This shows that the 3D images created according to the present disclosure outperform those created according to the prior art in terms of text correspondence, realism, and diversity.

Meanwhile, as described above, according to an embodiment of the present disclosure, an image with a restored pose and high text correspondence can be created by the pose-preserved diffusion model 20 or the sampling model 30. Therefore, a process of filtering target images used to construct the domain-adapted 3D model 300 is not necessarily required, which makes the pipeline more simplified and efficient. However, to achieve the highest quality, an additional filtering process may be performed to filter out a target image, which is less accurate or valuable, among target images created by the pose-preserved diffusion model 20 or the sampling model 30.

In an additional embodiment related to this, the server 100 can perform a filtering operation to select only a target image, which satisfies predetermined conditions, from among the target images created in the process S1120.

Specifically, the server 100 can filter out a target image, which shows a difference in the style indicated by the text that exceeds a predetermined threshold among the created target images. For example, the target images and the texts are input into respective encoders, sent to a common vector space and converted into vectors, and their similarity is measured. Herein, the similarity can be expressed as the difference in the sum of inner products of the vectors, and it can be defined as a cosine distance d in the vector space. The server 100 calculates the distance d for each target image, and removes a target image of which the calculated distance exceeds a predetermined threshold. Although the vector space is not particularly limited, a CLIP space may be preferred.

Also, there may be instances where a pose difference between a source image and a target image is relatively greater than those of other datasets. To prevent this, the server 100 may perform an operation to filter out a target image of which the pose distribution differs from that of the source image among the created target images.

The server 100 can filter out a target image, which shows a difference in pose from the corresponding source image that exceeds a predetermined threshold among the created target images. For example, the server 100 may use a pre-trained pose extractor. The pose extractor may predict pose information of the source image and the target image, and removes the target image when a score indicative of the difference between the pose information exceeds a threshold. In this case, a process of reconstructing the target image in the first domain may be performed to calculate the score. That is, actually, a difference in pose between the target image, which has been converted again to be in the first domain, and the source image can be calculated as a score.

The method and system of the present disclosure have been explained in relation to a specific embodiment, but their components or a part or all of their operations can be embodied by using a computer system having general-purpose hardware architecture.

The above description of the present disclosure is provided for the purpose of illustration, and it would be understood by a person with ordinary skill in the art that various changes and modifications may be made without changing technical conception and essential features of the present disclosure. Thus, it is clear that the above-described examples are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

### EXPLANATION OF CODES

100: 3D image creation server
130: Processor
300: Domain-adapted 3D generative model

What is claim is:

1. A 3D image creation method that is performed by a server and able to adapt to domains having a large gap, comprising:
(a) collecting a plurality of training data including a set of a depth map about a source image in a first domain, a text indicative of a style of a second domain, and a target image of the second domain;
(b) performing training to preserve a pose of the source image according to the depth map and converting the source image to be implemented in a style of the target image according to the text by using each of the training data; and
(c) creating a plurality of 3D images corresponding to a specific domain from noise data randomly input by using a domain-adapted 3D generative model constructed based on the training and a predetermined pose parameter,
wherein the source image and the target image are 3D images consisting of a plurality of poses associated with a plurality of camera viewpoints, and
the domain has at least one predetermined style, and the second domain is different from the first domain.

2. The 3D image creation method of claim 1,
wherein (a) collecting a plurality of training data comprises:
acquiring the source image by inputting the pose parameter and the random noise data into the 3D generative model previously trained on the first domain and acquiring a depth value by applying the acquired source image to a pre-trained depth estimation model.

3. The 3D image creation method of claim 2,
wherein (a) collecting a plurality of training data comprises:
acquiring the target image corresponding to the first domain in a different style from the source image by inputting the pose parameter and another noise data into the 3D generative model, and the text is set to correspond to the first domain.

4. The 3D image creation method of claim 1,
wherein (a) collecting a plurality of training data comprises:
acquiring the target image by converting the source image to match with the style indicated by the text through a pre-trained text-to-image diffusion model.

5. The 3D image creation method of claim 1,
wherein (a) collecting a plurality of training data comprises:
acquiring the target image by inputting the pose parameter and the random noise data into the 3D generative model previously trained on the second domain.

6. The 3D image creation method of claim 5,
wherein (a) collecting a plurality of training data comprises:
acquiring a target image corresponding to another second domain by applying the target image created by the 3D generative model to a pre-trained text-to-image diffusion model.

7. The 3D image creation method of claim 1,
wherein when the style set for the second domain includes a plurality of sub-styles, (b) performing training and converting the source image comprises:
further dividing the text into sub-texts corresponding to the respective sub-styles and creating target images in the plurality of sub-styles by inputting the sub-texts.

8. The 3D image creation method of claim 1,
wherein (b) performing training and converting the source image comprises:
constructing a sampling model that creates the target image by using a pose-preserved diffusion model constructed through the training and a pre-trained text-to-image diffusion model.

9. The 3D image creation method of claim 8,
wherein (b) performing training and converting the source image comprises:
generating a contour and a shape of the target image in a state where the pose of the source image is preserved through the pose-preserved diffusion model and then improving details of the target image through the text-to-image diffusion model.

10. The 3D image creation method of claim 8,
wherein (c) creating a plurality of 3D images comprises:
creating a plurality of target images consisting of poses of the source images for a plurality of second domains by converting a style of the source image according to an instruction indicated by a text input into the sampling model.

11. The 3D image creation method of claim 10,
wherein (c) creating a plurality of 3D images comprises:
constructing the domain-adapted 3D generative model by training the 3D generative model with a plurality of target images constructed by the sampling model.

12. The 3D image creation method of claim 1,
wherein (c) creating a plurality of 3D images comprises:
inputting the noise data and the pose parameter into the domain-adapted 3D generative model to output a new 3D image and performing fine-tuning of the output 3D image in a direction in which an adversarial loss caused by a difference between the output 3D image and the specific domain is minimized.

13. The 3D image creation method of claim 1,
wherein when at least one of a plurality of styles set for the specific domain is selected, (c) creating a plurality of 3D images comprises:
performing fine-tuning of a 3D image output from the domain-adapted 3D generative model corresponding to the selected style by using the noise data.

14. The 3D image creation method of claim 1,
wherein when a previously collected real 2D image is mapped to a 3D embedding space and input into the domain-adapted 3D generative model, (c) creating a plurality of 3D images comprises:
creating the 3D image by implementing a 3D embedding space corresponding to the specific domain.

15. A 3D image creation server, comprising:
a memory configured to store a program to perform a 3D image creation method that is able to adapt to domains having a large gap; and
a processor configured to execute the program,
wherein the processor is configured to, by executing the program,
collect a plurality of training data including a set of a depth map about a source image in a first domain, a text indicative of a style of a second domain, and a target image of the second domain,
perform training to preserve a pose of the source image according to the depth map and convert the source image to be implemented in a style of the target image according to the text by using each of the training data, and
create a plurality of 3D images corresponding to a specific domain from noise data randomly input by using a domain-adapted 3D generative model constructed based on the training and a predetermined pose parameter, and
wherein the source image and the target images are 3D images consisting of a plurality of poses associated with a plurality of camera viewpoints, and
the domain has at least one predetermined style, and the second domain is different from the first domain.
